(19) United States
(12) Patent Application Publication
(10) Pub. No.: US 2012/0066732 A1
(43) Pub. Date: Mar. 15, 2012

(54) System And Method Of Presenting An Interactive Video Package

(76) Inventors: James K. Devericks, Palm Beach, FL (US); Ainsworth J. Spence, JR., Boynton Beach, FL (US)

(21) Appl. No.: 13/233,782

(22) Filed: Sep. 15, 2011

Related U.S. Application Data
(60) Provisional application No. 61/383,195, filed on Sep. 15, 2010.

(51) Int. Cl. H04N 7/173

(52) U.S. Cl. 725/109; 725/116

(57) ABSTRACT

The present invention is a system and method by which a user can request specific media be sent to one of a number of different media display devices which the user owns or operates in real time. The display device, and thus the type of data stream supplied to the device, may be changed as often as desired by the user without loss of data transfer or video picture. The system automatically adapts to the display device to provide the best quality picture available for display on the particular device.

### CROSS REFERENCE TO RELATED APPLICATIONS

This application is related to U.S. Provisional Application No. 61/383,195 entitled “System and Method of Presenting an Interactive Video Package”, filed Sep. 15, 2010, the contents of which are incorporated herein in their entirety.

### FIELD OF THE INVENTION

The present invention relates to the request and presentation of media content to a number of different devices which are capable of receiving the media, and more specifically but not exclusively, to the request and presentation of digital media.

### BACKGROUND OF THE INVENTION

Many people today have different types of devices capable of receiving and displaying media in various forms, such as TV's, DVD players, PC's, PlayStations®, Wii®, iPhone®, Blackberry®, etc. Currently, different software is required to enable these devices to receive media from various sources. The software generally connects via wired or wireless networks to gain access to the internet. Media is found as pre-recorded programs that may be downloaded and viewed.

Currently the state of the art for interactive television is a set-top box. The user is required to install the set-top box to connect with the cable or satellite TV network(s) which they have in their home. The cable or satellite TV provider then controls the programming available to the user through the set top box. Users can often purchase additional programming through the set top box upon agreeing to pay the license fees associated with the programming. This construction limits the user to viewing the desired event or program wherever the set top box is located, typically the home. To view this type of programming the user must record the event or program at a later time. In addition, the homeowner may be away from the home at the time the event is broadcast, limiting his/her ability to record the program. Pay per view is very common for sporting events where wagers are often made and final results are broadcast almost immediately through other types of media. However, the broadcast of the final results often ruins the desire to watch a recorded version of the event.

Often media programming is purchased and the purchaser has a disruption that requires immediate attention, resulting in that person being unable to watch the entire program or event on the particular device it is being viewed on. That person may be able to view the event or program on their PC or smart phone the following day, provided that program was stored on a database that is accessible via the internet. However, special software must often be installed on their PC or smart phone to enable them to watch the program or movie. The person must then go to the web site and locate the desired program for download. If the person quit watching in the middle of the show, they must then advance the program to the desired point that they wish to continue watching. This may be particularly problematic for some programming, particularly sporting events. As stated earlier, many sporting events are available as pay per view only. Because some of these events are pay per view only, they require a specific box and/or software that only allows the programming to be viewed through that specific device. Thus, transfer of the programming from a set top device to an alternative device such as a cell phone for continued viewing is thus prevented. In addition, since results are published almost immediately through media outlets that did not have the rights to broadcast the event live, viewing of the recorded event is not desirable.

Thus, there is a need in the art for a system and method for broadcasting real time video to the media device of the user's choice without limitation to specific set top boxes or encoders. The system and method should allow the user to transfer the event or program from one media device to another during the broadcast without loss of viewing rights or the purchase of an additional license to view the event.

### SUMMARY OF THE INVENTION

The present invention is a system and method by which a user can request specific media be sent to one of a number of different media display devices which the user owns or operates in real time. The display device, and thus the type of data stream supplied to the device, may be changed as often as desired by the user without loss of data transfer or video picture. The system automatically adapts to the display device to provide the best quality picture available for display on the particular device.

Accordingly, it is an objective of the instant invention to provide a system wherein an individual can request certain information or services and the information or services can be provided to the user's media device.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic of how the system of the present invention operates; and

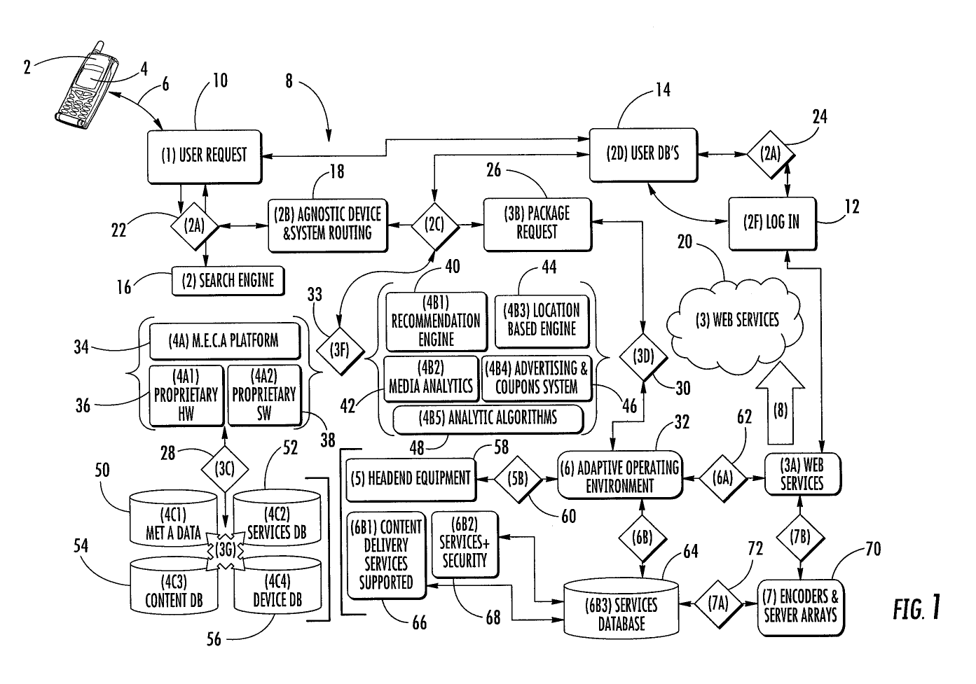

FIG. 2 is an example of one embodiment of the present invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention relates to an electronic network 8 of servers and databases by which a user can request specific media be sent to one of a number of different media display devices which the user owns or operates. Currently, users are able to request different media, such as TV programs or movies, be sent to their televisions by using a set-top box. These set-top boxes are connected to a media supplier, such as a cable TV network or a satellite TV network. The user is restricted to the programming and movies available from the specific cable provider or satellite TV provider. Users are also able to download certain television shows onto their personal computers utilizing software which establishes an interface between the media supplier and the user's computer.

Currently, media available from a cable provider or satellite provider is not readily available on devices other than televisions. Also, certain other media suppliers, such as Netflix®, can supply media to a personal computer or send a DVD through the mail so that the user can play it on their DVD player. Connection of the media to a television is typically accomplished by connecting the computer to the television via an internet ready device such as a Wii®.

The present invention includes a system wherein media from a number of different and varied sources is delivered to a user upon request by the user. The system further enables the delivery of the requested media to any number of various media display devices without the need for special software or special user interfaces. In a preferred embodiment, a user will make a request 10 for some media from a device that the user owns or is operating. Examples of these devices are television, Playstation®, Roku, iPad®, iPhone®, and Blackberry®. In addition, other devices, similar to those listed, can be employed to request and receive media. The information retrieved from the search request will be in a digital format. Pictures, text, e-mails, audio and video will be broken down into digital information based around the content source and the playback capabilities the user's device. This information retrieved is sent to either a user login 12, a user database 14, or filtered through a search engine 16. Information from the search engine 16 can also be sent through an agnostic device and system routing 18 which identifies the user's device and associates a quality of service that can be provided by the system to the user's device.

The user's request 10 is preferably in digital form. It can be in the form of a text message, a voice message, an e-mail, an instant message, a picture, etc. The request is sent from a local device that the user is currently operating, an iPhone®, a Wii®, etc. The request is processed through the systems various databases, imaging database, audio database, meta data database and device database.

A request can also come in from an outside third party server. The request is filtered and routed through the search engine servers 16. The request is next matched against devices that the user has registered with the system to prevent multiple logins. This enables a user to make a request for certain media for one of his/hers devices from a device or computer which is not associated with him/her on the system. The requested media is then processed through imaging databases, audio databases, meta databases, and device databases to determine if the request can be delivered to the user's device.

The search engine 16 and associated servers receive the user's request 10 in digital format through agnostic device and system routing 18. These servers enable communication utilizing a systems management server (SMS) and web services. These servers enable the request to be processed live or as soon as it is received from a user. The digital request is then processed through the system's imaging databases, audio databases, meta databases and device databases to identify the user, the device or the service requested by the user. Having this information, the web services 20 can then grant or restrict the requested content or requested services. These services can include streaming services and other platform services.

The agnostic device and system routing 18 operate within the network of the system to process the user's request. Communication between the system network servers and the core components of the system architecture enable the system to capture and process the data requested by the user into useful information. This information is packaged into data which permits the platform of the system to create a service based on live or on demand content (video, music, games, etc). It can also place advertisements into the media requested. Further, it can determine which advertisements are appropriate for the content of the request. This enables advertisers to target specific individuals which they believe would most likely respond to their advertisements.

The system utilizes a communication server 22 which processes the request to enable the response to be utilized by the user or requestor. For example, the request can be for video, audio, text, picture, etc. content. The communication server recognizes the user's device and assures that the response to the request can be displayed or utilized by the user on their device.

The system also includes a user database 14. This database includes information regarding access granted to individual users, devices associated with specific users, purchasing habits of individual users, etc. This information enables the system to correctly coordinate the response to a request with the user's device from which the request has been made so as to enable the user to view/use the response. The purchasing habits of a user enable certain advertisements to be directed to user when appropriate. These habits further assist the system in obtaining the more appropriate response whenever there are two or more equivalent responses available to an individual request.

The system utilizes another communication server 24 which processes the request to enable the response to be utilized by the user or requestor. For example, the request can be for video, audio, text, picture, etc. content. The communication server recognizes the user's device and assures that the response to the request can be displayed or utilized by the user on their device.

The system further includes a user login portal or point 12. This login validates the user, their device, the content of their request and the services requested so that the appropriate response to the user's request is delivered or supplied to the user. This point further enables a user to login to the system from a device other than the specific devices associated with the user. Further, the login prevents multiple logins using the same user identification.

The Web services 20 are services from third parties that are made available to the user upon request. These services can include specific media or other information. These services are available over the Internet or through other wireless communications.

The user requests are packaged and processed at package request system 26 to ensure that the user receives a response to their request in a format that can be displayed on the user's device. For example, if the request is in a text format and the request is for a video format, the system will determine at this point if the device from which the request is being placed can receive and display video data. The various forms in which the request can be made and the response received include text, e-mails, internal network messaging, voice data, video data, etc. A purpose of registering specific devices with specific users is to protect the digital content of these devices. Another purpose is to protect the online identity of the user. The protection of the online identity is especially critical in today's Internet world. The requests are processed through imaging databases, audio databases, meta data databases and device databases. After this processing, the data generated is attached to the specific request so as to enable the response to be correctly packaged and presented to the user based on their devices, identification and past user history.

A first communication server 33 compares the components against which the user's request has been made. The first communication server is in electronic communication with an M.E.C.A. platform 34 which is a total compilation of all of the system's servers, software and hardware. The M.E.C.A. platform includes proprietary hardware 36 which enables the system to operate. This hardware aids in the processing of various requests from numerous users on different devices. The responses to the requests can also be delivered to the various devices utilizing propriety hardware 36.

The proprietary software 38 operates on the proprietary hardware 36 to enable the system to receive and process various requests from various user devices and deliver the proper responses to the individual user on whichever device they determine that response is to be received in a format which is readable and can be displayed by the chosen device. This construction also permits the user to switch the device that is being utilized during any portion of the viewing. For example, a user may need to run an errand during the viewing of a live sporting event. In this example, the user may want to switch between viewing on his home big screen television to viewing on a smart phone so that details of the sporting event are not missed. Once the errand is completed, the user may want to switch back to viewing on the big screen television or the user may want to switch to viewing on a lap top computer if the errand was to his/her office.

The system utilizes a second communication server 28 which processes the request to enable the response to be utilized by the user or requestor. The data bases 50, 52, 54 and 56 are queried for information relevant to the request of the user.

The system utilizes a third communication server 30 which processes the request and sends it onto the adaptive operating environment 32. The adaptive operating environment takes in information relating to the request and processes it through servers 28 and 30.

A search engine 40 processes the data from the user(s) and the digital media to determine which data and what type of digital media is to be sent to each user in response to each of their requests.

A Media Analytics server 42 analyzes the data media based on the usage of the data.

A Location Based Engine server 44 and software thereon provide an engine which determines how the information is to be transformed at each step of the process of the request.

An Advertising and Coupons System server 46 includes advertising which is associated with each search request. The appropriate advertising and other content is then associated with the responses and delivered to the individual users.

An Analytic Algorithms server 48 contains the proprietary algorithms which are used in the processing of the requests, determination of what the correct responses are, where the responses should be sent, and in what format.

A Meta Data server 50 includes a database of meta data.

A Services DB server 52 is a database content which is constantly updated live to ensure the latest and proper responses are delivered to the users.

A Content Database server 54 is a database of the content available to the users.

A Device Database server 56 is a database of the numerous user devices. This server verifies that the user's device can accept the digital media stream which is sent to the Internet and the end publishing point through the CDN providers of the system. The user's device sends the digital request into the system. The appropriate stream to process the request is made available through the CDN partners of the system. Devices which are not registered by users can be verified against the user login 12 and user database 14.

58 is the headend equipment from which the responses to the requests are obtained. The responses are encoded at this point. The information and digital media are streamed to the Internet, the end publishing point through the CDN providers of the system. The local device of the user sends the request. This headend equipment 58 allows access to the same cable feeds that operators such as Comcast and Time Warner have, thus enabling the user to be supplied with the appropriate digital media response to their request. The content from these requests are the mainstream channels and mainstream media data bases which reside locally on the web. The stream of the media which the user access is secured to the session that the user is tuned into at that time. The stream is made available through the CDN partners the system utilizes so that it appears that the user is receiving the media directly from any source such as Dish TV, Cable TV, Direct TV, etc.

The system utilizes a fourth communication server 60 which processes the media content from the headend equipment 58. This server enables the content from the headend equipment 58 to be sent to the adaptive operating environment server 32 to check it against the user's database to determine if the package request is a real service which can be provided to the user.

A fifth communication server 62 transforms the information from the requests and responses between the web services 20 and the adaptive operating environment 32 to assure compatibility.

Services database 64 functions to provide pricing and rights management information to the encoders and server arrays through the fourth communication server 60 in response to a user request 10.

Content delivery database 66 is constructed and arranged for management of pricing with respect to intellectual property rights and licenses. This database attaches a service fee to the user's request based on the rights (territorial, digital content, data, etc.) of the user request. The user is then billed appropriately for the service if utilized.

A services and security database 68 is in electrical communication with said services database 64 and said fourth communication server 60. The system and security database permits or restricts service access to users based on rights or licenses purchased. These rights may relate to territory, digital content, data, etc. and may be changed at various times by the user or the management of the system.

Encoders and server arrays 70 tests and actively monitor the electronic network system 8 and user requests 10 for services. In a preferred embodiment, the optimal quality of video is delivered at or below 1 MB per live channel. This is a sliding scale which responds to the network connection and chosen device capabilities independent of the user having to adjust his device or the network connection. Once the system identifies the device being used by the user, the device databases 56 are updated to address the delivery to the user. The quality of images transferred to the device is monitored so that, if HD quality is not available, the reception is switched to SD. If SD is not available, then the system steps down the quality to whatever is available to maintain service in the system for delivery of the user request to the chosen device. The compression quality permits the system to deliver a live H.264 stream customized for devices in networking. The system's web centric service permits access across legacy networks (Cable, Docsis, DSL, WiFi, WiMax, 2.5 G\3 G\4 G Media Flo, Fiber, Mobile Broadband, copper networks). The ability to ride above the other networks and supply high quality digital media is accomplished through auto sensing streaming services.

The communication device 72 transforms information. The device requests will be purely digital (video, audio, text, picture, etc.). Therefore the response should be digital (video, audio, text, picture, etc.). The initiation of the proper service to provide the digital response is made through accessing the sites services. The encoders and server arrays 70 configure the approved digital stream of content to the test servers running in parallel with the line servers. The users will receive the streams after they have been tested completely.

Information regarding the user requests and responses is constantly updated. Additional devices associated with each user are continually added to the databases in the system. The paths which the requests take and the paths of the response(s) to the user are continually updated. Finally, the ability of individual users to access or be restricted from access to certain services is continually updated.

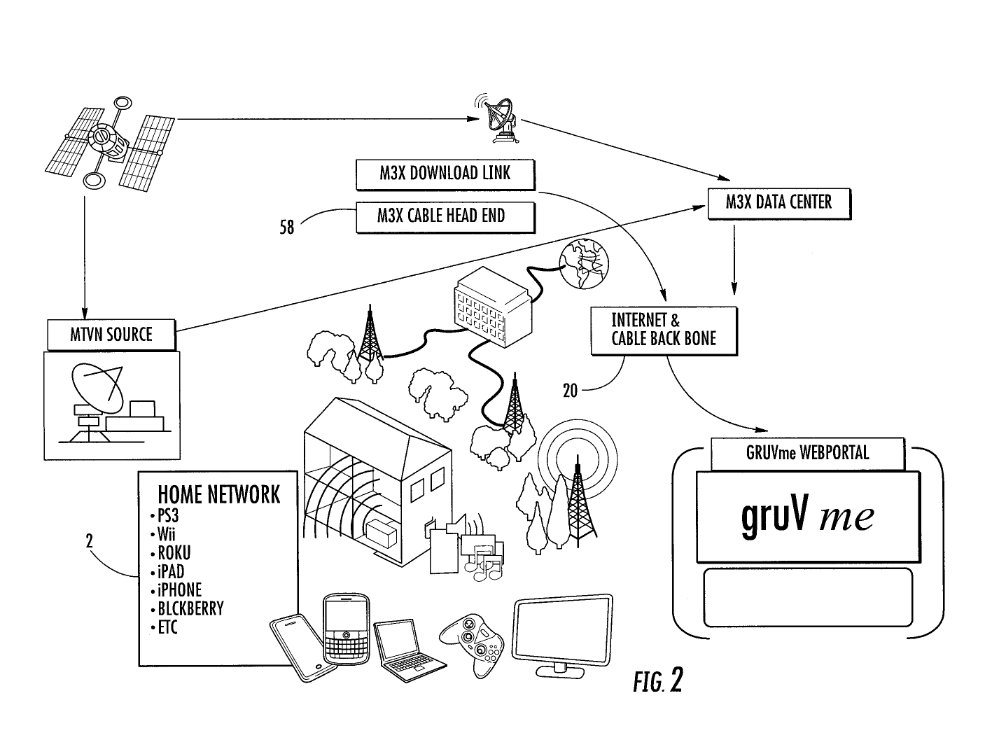

FIG. 2 represents one embodiment of how the system of the present invention can be implemented.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of providing real time television video to a variety of electronic devices having different capabilities and requirements including:
providing an electronic network 8 of servers and databases that are in electric communication with each other to transfer digital information regarding said real time video in a variety of formats to an electronic device chosen by a user, said electronic network 8 being constructed and arranged to determine said electronic device capabilities and format requirements for optimization upon log in of said user to said electronic network 8, whereby said digital information is customized to said electronic device and said electronic device and said format can be changed at any time during display of said real time video.

2. The method of claim 1 including:
providing an electronic device 2 that is constructed and arranged for bi-directional communication with an internet, said electronic device 2 having a display 4 for viewing of information transferred to and from said internet, said electronic device having a format for transferring said information to and receiving information from said internet for view on said display;
providing a bi-directional connection 6 to said internet;
providing a user request 10 for a video program from said electronic device, said user request 10 transferred digitally to a user database 14;
providing a user database 14 for receiving said user request 10, said user database 14 including information regarding various electronic devices registered to a particular user, whereby data transmission is optimized to said electronic device 2 in response to said information contained on said user database;
providing a user login portal 12, said user login portal 12 in electric communication with said user database 14, said user login portal 12 constructed and arranged to validate access to said electronic network 8 in response to said user request 10.

3. The method of claim 2 including:
providing an agnostic device and system router 18, said agnostic device and system router 18 being constructed and arranged to identify a device not registered on said user database 14, said agnostic device and system router 18 constructed and arranged to optimize data transmission to said not registered device, said agnostic device and system router 18 constructed and arranged to transfer data regarding said not registered device to said user database 14 whereby said device is thereafter registered.

4. The method of claim 3 including:
providing a search engine 16, said search engine 16 constructed and arranged to process searches received from various types of electronic devices 2, said search engine 16 in electric communication with said agnostic device and system router 18 as well as said user database 14, whereby search results relevant to said electronic device 2 are communicated back to electronic device 2 for selection by a user.

5. The method of claim 4 including:
providing a first communication server 33, said first communication server in electric communication with an M.E.C.A. platform 34, said M.E.C.A. platform 34 including a compilation of the electronic network 8 databases, servers, software and hardware.

6. The method of claim 5 including:
providing a second communication server 28, said second communication server in electric communication with meta data base 50, services database 52, content database 54 and device database 56, said second communication server 28 being constructed and arranged to process said user request 10 by querying said meta data base 50, services database 52, content database 54 and device database 56 for data and format relating to said user request 10.

7. The method of claim 5 including:
providing a third communication server 30, said third communication server 30 in electric communication with said first communication server 33 and said second communication server 28 whereby information relating to said user request 10 is transferred from said first and said second communication servers to said third communication server 30, said third communication server passing said data relating to said user request through an adaptive operating environment 32 for checking the data received from said first and said second communication servers 33, 28 for said electronic device capabilities and format requirements stored within said equipment user database 14.

8. The method of claim 7 including:
providing a fourth communication server 60, said fourth communication server 60 in electric communication with headend equipment 58 and said adaptive operating environment 32, whereby data relating to said user request 10 is passed through said headend equipment and transferred to said adaptive operating environment for determination of compatibility with said electronic device capabilities and format requirements stored within said equipment user database 14.

9. The method of claim 8 including:
providing a fifth communication server 62;
providing web services 20, said web services provided by third parties and transferred into said electronic network via an internet connection, said fifth communication server 62 in electric communication with said web services 20 and said adaptive operating environment 32, whereby said fifth communication server 62 transfers data received from said web services 20 through said adaptive operating environment 32 for determination of compatibility with said electronic device capabilities and format requirements stored within said equipment user database 14.

10. The method of claim 9 including:
providing a services database 64, said services database in electrical communication with said fourth communication server 60 to provide pricing and rights management information in response to said user request 10.

11. The method of claim 10 including:
providing a content delivery database 66, said content delivery database 66 in electrical communication with said services database 64 and said fourth communication server 60, said content delivery database constructed and arranged to provide pricing with respect to said user request 10, said pricing based on content and territorial rights.

12. The method of claim 11 including:
providing a services and security database 68, said services and security database in electrical communication with said services database 64 and said fourth communication server 60, said services and security database being constructed and arranged to restrict service access based on rights purchased.

13. The method of claim 12 including:
providing an encoder and server array 70 for testing and actively monitoring said electronic network system 8 and user requests 10 for services, said server and encoder array constructed and arranged to deliver optimal quality video at or below 1 MB per live channel, said encoder and server array 70 constructed and arranged to automatically step up or step down data transfer rates based on the ability of said user device 2 to accept data.
